(19) United States
(12) Patent Application Publication
(10) Pub. No.: US 2026/0014798 A1
(43) Pub. Date: Jan. 15, 2026

(54) USAGE CONTROL FOR CONSUMABLES OF A PRINT APPARATUS

(71) Applicant: HEWLETT-PACKARD DEVELOPMENT COMPANY, L.P., Spring, TX (US)

(72) Inventors: Maurizio BORDONE, Sant Cugat del Valles (ES); Pol VINARDELL SERRASOLSAS, Sant Cugat del Valles (ES); Estefania SERRANO LOPEZ, Sant Cugat del Valles (ES)

(73) Assignee: HEWLETT-PACKARD DEVELOPMENT COMPANY, L.P., Spring, TX (US)

(21) Appl. No.: 18/994,962

(22) PCT Filed: Jul. 21, 2022
(86) PCT No.: PCT/US2022/037881

§ 371 Date: Jan. 15, 2025

(51) Int. Cl. B41J 2/175; B41J 2/185; G06F 3/12

(52) U.S. Cl. CPC B41J 2/17566; B41J 2/185; G06F 3/1219; B41J 2002/1856

(57) ABSTRACT

In an example, a method may include monitoring usage of each of a plurality of consumables within a replaceable element of a print apparatus. The method may include determining, for an action of the print apparatus, whether the plurality of consumables can be used interchangeably. In response to determining that the plurality of consumables can be used interchangeably, the method may include controlling the print apparatus to select a less used consumable from the plurality of consumables for the action, based on the monitored usage.

### BACKGROUND

Print apparatuses may use a number of consumables including printing fluid, print substrates and the like. Some of these consumables may be stored within a replaceable element that is to be replaced in the printing apparatus once the consumable is used up. For example, a print cartridge may contain print fluid that will be used up over time, at which point the cartridge is replaced. A maintenance cartridge may contain print fluid waste areas such as a tank or spittoon, or a web of absorbent material used to wipe a portion of the print apparatus (e.g. a printhead). A maintenance cartridge may be filled up with waste print fluid over the lifetime of the cartridge, at which point the cartridge is replaced.

### BRIEF DESCRIPTION OF THE DRAWINGS

Non-limiting examples will now be described with reference to the accompanying drawings, in which:

FIG. 1 shows a schematic representation of an example method, which may be a method for balancing usage of consumables of a replaceable element of a print apparatus;

FIG. 2 shows a schematic representation of another example method, which may be a method for balancing usage of print fluid waste areas of a maintenance cartridge;

FIG. 3 shows a schematic representation of an example print apparatus; and

FIG. 4 shows a schematic representation of an example machine-readable medium in association with a processor.

### DETAILED DESCRIPTION

Print apparatuses often use replaceable elements or parts that have a shorter expected lifetime than the print apparatus itself and are to be replaced multiple times over the lifetime of the print apparatus. Some replaceable elements may include a consumable resource, or a plurality of consumables, which are used up during operation of the printing device. In some cases, where a replaceable element includes a plurality of consumables, usage between these consumables may be unbalanced. For example, usage of different consumables may depend on how the print apparatus is used by the user (e.g. due to which print modes are used, how often the print apparatus is used, what type of jobs the print apparatus is used for etc). Once one of the consumables is used up, a user will be asked to replace the replaceable element. However, if the usage of the consumables was unbalanced, another consumable may not be used up. Unbalanced usage of consumables may therefore lead to replaceable elements being replaced before all of the consumables on that element have been used up. Therefore, wastage of consumables occurs. Furthermore, unbalanced usage may lead to the replaceable element being replaced more often than necessary. This increases costs for users and decreases sustainability. In addition, replacing elements in the print apparatus causes unwanted printer downtime and increased demands for user input to perform the replacements.

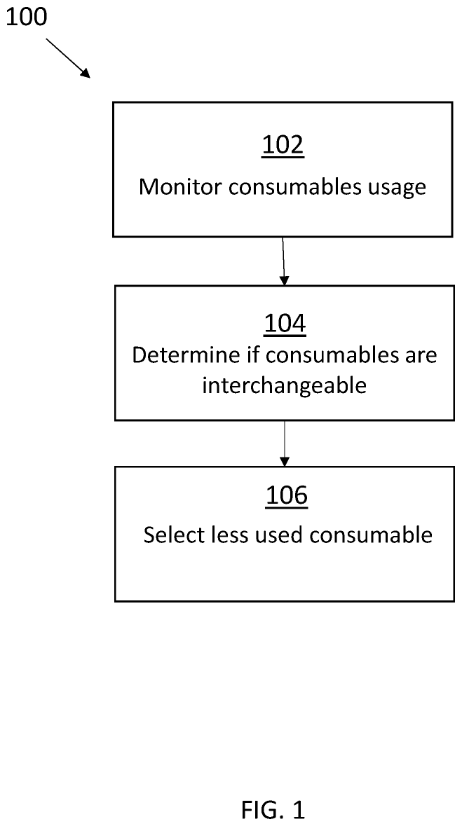

FIG. 1 shows a flowchart for a method 100, which may be a method for balancing usage of consumables of a replaceable element of a print apparatus. Block 102 of method 100 comprises monitoring usage of each of a plurality of consumables within a replaceable element of a print apparatus. The print apparatus may be, e.g. an inkjet printer, a 3D printer, or another type of printer. The replaceable element may be, for example, a replaceable cartridge, such as a maintenance cartridge or a print fluid cartridge. The consumables may be e.g. printing fluids or other resources that are used up over the lifetime of the replaceable element, thereby leading to replacement of the replaceable element, for example a tank, or an absorbent material to receive print fluid waste which may get filled up over the lifetime of the replaceable element. Monitoring usage of the consumables may comprise using a counter or tracker which is updated or incremented each time a consumable is used, which may thereby keep count of how much of each consumable has been used. In some examples, monitoring usage of a consumable may comprise detecting how much of a consumable is still available using a sensor, e.g. a level sensor within a tank. The plurality of consumables may comprise e.g. two consumables, or more than two consumables, which may be different types of consumable.

Block 104 comprises determining, for an action of the print apparatus, whether the plurality of consumables can be used interchangeably. The action may be, for example, a printing action, a pre or post print action to be performed by the print apparatus, or a cleaning or maintenance action that uses up part of one of the plurality of consumables. I.e. Block 104 comprises determining, for a particular action which of the consumables can be used. Some actions may make use of a particular consumable. However, for other actions it may be that there is more than one type of consumable that could be used to perform the action.

In response to determining that the plurality of consumables can be used interchangeably, the method 100 may comprise at block 106, controlling the print apparatus to select a less used consumable from the plurality of consumables for the action, based on the monitored usage. For example, the method may comprise determining which consumable has been used more so far, or which consumable is closer to being used up, in order to select a less used consumable. The method may also include performing the action.

The method of FIG. 1 therefore enables balancing of consumables in the replaceable element, which reduces wastage and increases the lifespan of the replaceable element.

As noted above, in some examples, the replaceable element may be a maintenance cartridge. In some examples, the consumables may be print fluid waste areas within a maintenance cartridge. A maintenance cartridge may include a plurality of print fluid waste areas to receive print fluid (e.g. ink) generated by the print apparatus in an print fluid waste action. An example of a print fluid waste action is a spitting action, e.g. firing a nozzle to unclog it. Another example of a print fluid waste action is a wiping action, in which the print heads are wiped to remove excess print fluid via mechanical friction. Another example of a print fluid waste action is a priming action in which a nozzle is controlled to increase pressure within the nozzle to move a small amount of print fluid out of the pen. Each of these actions generates print fluid waste.

In some examples, a print fluid waste area may be an absorbent material which may be used to wipe print heads by controlling a carriage in the print apparatus to move the absorbent material across the print head. In some examples, the absorbent material may be e.g. a sponge. In some examples, the absorbent material may be a roll of absorbent material also referred to as a web. In some examples, the cartridge may include multiple different waste areas that comprise an absorbent material, or different areas of an absorbent material may be defined as different waste areas. Over the lifetime of the maintenance cartridge the absorbent material may be used up as it becomes covered in print fluid and so eventually the maintenance cartridge may need to be replaced.

In some examples, a print fluid waste area may be a tank or container, also referred to as a spittoon for receiving and holding print fluid from print fluid waste actions. In some examples, the print fluid waste area may include a roller or set of rollers located over the tank. Over the lifetime of the maintenance cartridge, the tank may fill up with waste print fluid. Once the tank is full, the maintenance cartridge is to be replaced. In some examples, a maintenance cartridge may include multiple print fluid waste tanks.

A maintenance cartridge may include a plurality of different ink waste areas, for example an absorbent material and a tank, which may be used for different types of print fluid waste action. Depending on how the print apparatus is used, different ink waste areas may fill up at different rates. For example, in some cases, the web may fill up first, triggering replacement of the maintenance cartridge even though the tank still has capacity. In other cases the tank may fill up first, triggering replacement of the cartridge even though the web still has capacity. These situations can therefore lead to increased waste as the cartridge is being replaced before all of the consumables have been used up. Balancing usage of the different print fluid waste areas can therefore lead to more efficient usage of resources and increase the useable lifetime of the cartridge.

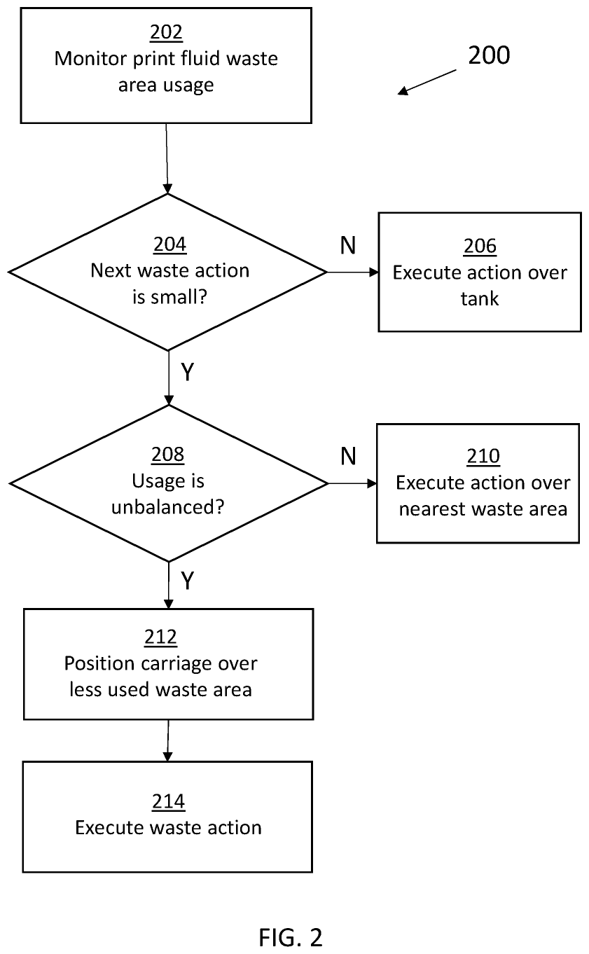

FIG. 2 shows a method 200 which may be a method for balancing usage of print fluid waste areas of a maintenance cartridge. Method 200 may be an example of method 100.

Block 202 comprises monitoring usage of each of a plurality of print fluid waste areas within a maintenance cartridge of a print apparatus. For example, each waste area may be associated with a print fluid counter. The amount of print fluid used in each waste action may be well controlled, and therefore pre-defined for each action. For each waste action, a controller may therefore determine how much print fluid is used and which waste area it has been discharged over. In some examples, the print fluid counter may keep track of how much of a print fluid waste area has been used up or filled up, or what the remaining capacity of the print fluid waste area is. Monitoring usage of each of the waste areas may therefore comprise evaluating counters for each print fluid waste area.

Block 204 comprises determining, e.g. by a controller, whether the print fluid waste areas can be used interchangeably for a particular print fluid waste action. Block 204 may include evaluating the next waste action and determining how much print fluid will be discharged. This may comprise determining what type of action the next waste action is.

In some examples, print fluid waste actions may be categorized as either large waste actions, small waste actions or no waste actions. Large waste actions may be defined as actions that create a high amount of waste print fluid, such as unclogging actions executed as part of recoveries, or after not using the printer for a long time. Large waste actions may be executed over a tank, since absorbent materials may not be able to absorb such a high amount of print fluid in normal conditions and executing a large waste action over these ink waste areas may cause unwanted build-up or leaking of waste print fluid. No waste actions may comprise actions that do not involve dispensing a significant amount of print fluid. For example, cleaning actions such as wiping or scrubbing may be included in this category. Small waste actions may comprise actions that involve wasting a small amount of print fluid, for example spitting a low amount of print fluid or recirculating the print fluid inside the print head.

In example method 200, block 204 comprises determining if the next waste action is a small waste action (i.e. will discharge a small amount of print fluid). If the action is a small waste action, a controller may determine that the action may be executed over either an absorbent waste area or a tank waste area. In some examples a small waste action may be defined as a waste action with an amount of print fluid waste less than a predefined threshold. The predefined threshold may be set based on how much print fluid can be comfortably absorbed by the absorbent waste area, which may depend on material properties e.g. absorbency, thickness etc of materials used in the absorbent waste area. In some examples, for types of waste actions that will generate a greater amount of ink, the controller may determine that the action should be executed over a tank to prevent unwanted excess print fluid around the absorbent material. In that case, the method may proceed to block 206 which comprises executing a large waste action over a tank.

In method 200, if the controller determines that the waste action is a small waste action, the method proceeds to block 208. Block 208 comprises comparing usage levels of each of the plurality of waste areas. For example, the cartridge may include a first waste area (e.g. an absorbent material such as a web) and a second waste area (e.g. a tank). Block 208 comprises determining whether the usage of the first waste area is greater or less than the usage of the second waste area. Block 208 may comprise retrieving counter values as generated in block 202 for each of the first and second waste areas. The controller may determine that usage of the first and second waste areas is substantially equal, e.g. the counters have relative values that are within pre-defined boundaries. In that case, the method may proceed to block 210 and the controller may control the print apparatus to execute the waste action over the nearest waste area.

In response to determining that the usage is unbalanced at block 208, the method 200 proceeds to block 212. At block 212, the controller controls a carriage of the print apparatus to position a nozzle which is to perform the waste action over a less used waste area. For example, if the controller determined at block 208 that the first waste area (a web) was less used, then block 212 comprises controlling a carriage of the print apparatus to position the nozzle(s), over the web and execute the waste action.

In some examples, the method 200 may include a block (not shown) of determining whether there is more than one type of waste area available. In some examples, for spitting areas of the same type, the method may comprise controlling the print apparatus to execute a waste action over the nearest waste area, in order to complete the waste action more quickly. In some examples, even for waste areas of the same type, the method may comprise determining which of these areas has been used less. For example, where the cartridge includes two tank areas, the method may comprise determining which of the tanks has more capacity.

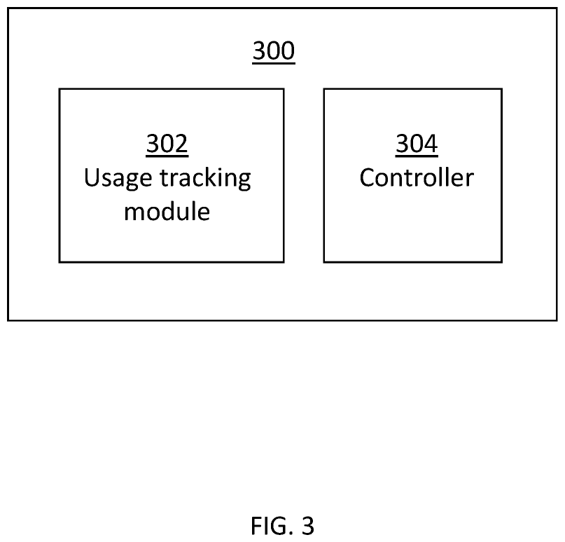

FIG. 3 shows an example print apparatus 300. The print apparatus 300 may be to perform the method of FIG. 1 and/or FIG. 2.

The print apparatus 300 comprises a usage tracking module 302, to track usage of each of a plurality of consumables within a replaceable element of the print apparatus and a controller 304, wherein the controller 304 is to select, for an action of the print apparatus 300, which of the plurality of consumables to use. the controller 304 is to select a less used consumable of the plurality of consumables, based on the tracked usage. The print apparatus may comprise a printer, such as an inkjet printer, 3D printer or another type of printer.

The usage tracking module may comprise a separate counter for each consumable that is updated (e.g. incremented or reduced) each time that consumable is used. For example, the counter may be updated in response to determining that an instruction to perform an action using a particular consumable has been executed.

In some examples, the replaceable element of the printer 300 for which usage is to be tracked by the usage tracking module comprises a maintenance cartridge. The action of the print apparatus 300 may be a print fluid waste action, i.e. an action that generates waste print fluid which is not used directly for printing. Examples of print fluid waste actions may include e.g. spitting, wiping and other actions for cleaning, priming or removing air bubbles or clogs from nozzles.

In some examples, each of the plurality of consumables may be a print fluid waste area, wherein a print fluid waste area is an area to receive waste print fluid during a print fluid waste action. The print fluid waste areas are consumables in the sense that they can be used up by being filled up, at which point the maintenance cartridge will be replaced by a user.

In some examples, the controller 304 may select which of the plurality of consumables to use based on tracked usage and also based on an expected amount of print fluid to be dispensed during the print fluid waste action. For example, the controller 304 may select a less used consumable (e.g. a less used waste area) for actions that are expected to dispense a small amount of print fluid. For other types of actions, the controller 304 may determine that the consumables are not interchangeable, and may select a consumable (e.g. a waste area) based on the amount of print fluid that is expected to be dispensed.

In some examples, the controller 304 may select which of the consumables to use based on which of the consumables is most easily accessible, based on a current state of the print apparatus. For example, the controller may select which of a plurality of consumables to use based on a current position of the maintenance cartridge relative to a printhead or to a print fluid dispenser nozzle which is to perform the action. For example, a printhead may be mounted on a carriage of the print apparatus which is moveable to move nozzles of the printhead over different waste areas of a maintenance cartridge. In some examples, the maintenance cartridge is also mounted on a carriage and the maintenance cartridge is moved to align a print waste area of the maintenance cartridge with the print fluid. In some examples, both the maintenance cartridge carriage and the printhead carriage may be moved to align printhead nozzles with a print waste area. The controller 304 may determine which of the waste areas is currently closest based on a current position of the maintenance cartridge relative to the printhead.

Once a print fluid waste area has been selected, the controller 304 may move a carriage of the print apparatus (not shown) to position the maintenance cartridge relative to a print fluid dispenser nozzle or nozzles which is to perform the print fluid waste action, to receive print fluid from the print fluid dispenser nozzle or nozzles in the selected print fluid waste area.

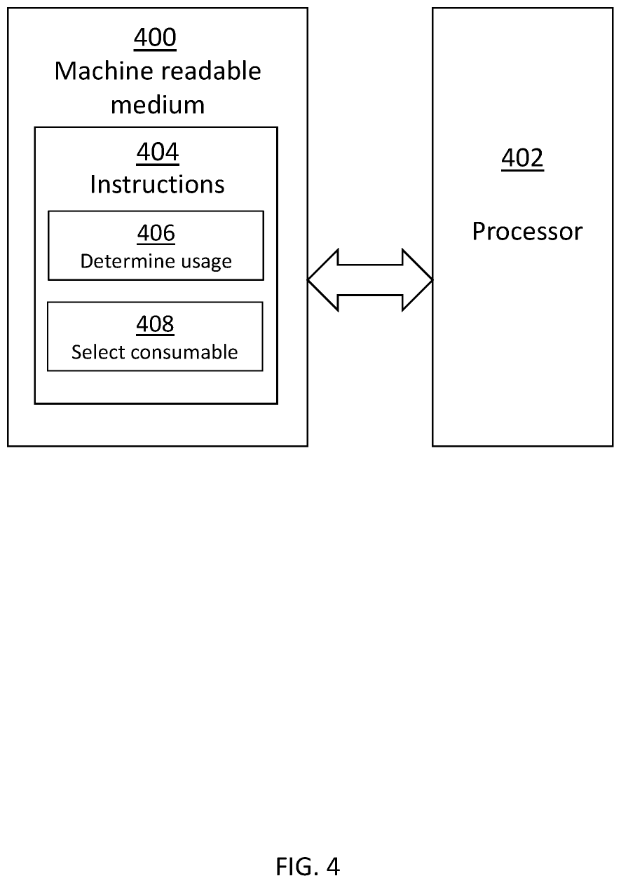

FIG. 4 shows an example non-transitory machine readable medium 400 in association with a processor 402. The machine readable medium 400 may comprise instructions to perform the method of FIG. 1 or FIG. 2. The machine readable medium 400 and processor 402 may be part of the print apparatus 300 of FIG. 3. For example, the controller 304 may comprise the machine readable medium 400 and processor 402.

The machine readable medium 400 stores instructions 404 to be executed by the processor 402. The instructions 404 include instructions 406 to determine a usage level of a first consumable and a second consumable of a replaceable element of a print apparatus.

Instructions 408 comprise instructions to, for an action of the print apparatus that can use either the first consumable or the second consumable, determine whether to use the first consumable or the second consumable based on the determined usage levels.

Instructions 400 may include instructions to receive an indication that an action is to be performed. In some examples, instructions 406 and/or instructions 408 may be executed in response to receiving such an indication. For example, the indication may comprise an indication to perform a maintenance action e.g. in response to a determination that the print apparatus has been idle for a certain amount of time, or in response to a determination that a certain amount of time or printing operations has passed since a maintenance action was previously performed.

Instructions 406 may comprise retrieving a tracking counter associated with each of the first and second consumables, wherein each tracking counter indicates a usage level of that consumable. In some examples, the instructions 400 may include instructions to perform the action using the determined consumable and update the tracking counter associated with the determined consumable.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A method comprising:
monitoring usage of each of a plurality of consumables within a replaceable element of a print apparatus;
determining, for an action of the print apparatus, whether the plurality of consumables can be used interchangeably;
in response to determining that the plurality of consumables can be used interchangeably:
controlling the print apparatus to select a less used consumable from the plurality of consumables for the action, based on the monitored usage.

2. A method according to claim 1, wherein the replaceable element is a maintenance cartridge.

3. A method according to claim 2, wherein the action is a print fluid waste action.

4. A method according to claim 3 wherein the consumables are print fluid waste areas, to receive print fluid generated in a print fluid waste action.

5. A method according to claim 3, wherein controlling the print apparatus to select the consumable comprises controlling a carriage of the print apparatus to position a nozzle, which is to discharge printing fluid in the print fluid waste action, over one of the plurality of print fluid waste areas.

6. A method according to claim 4, wherein determining whether the plurality of consumables can be used interchangeably comprises determining the amount of print fluid waste to be generated by the print fluid waste action.

7. A method according to claim 4, wherein a first print fluid waste area of the plurality of print fluid waste areas comprises a tank for receiving print fluid waste and a second print fluid waste area of the plurality of print fluid waste areas comprises an absorbent material for receiving print fluid waste.

8. A print apparatus comprising:
a usage tracking module, to track usage of each of a plurality of consumables within a replaceable element of the print apparatus; and
a controller, wherein the controller is to select, for an action of the print apparatus, which of the plurality of consumables to use;
wherein, for actions where more than one of the plurality of consumables can be used, the controller is to select a less used consumable of the plurality of consumables, based on the tracked usage.

9. A print apparatus according to claim 8, wherein the replaceable element is a maintenance cartridge and the action is a print fluid waste action.

10. A print apparatus according to claim 9, wherein the controller is to select which of the plurality of consumables to use based on an expected amount of print fluid to be dispensed during the print fluid waste action.

11. A print apparatus according to claim 9, wherein each of the plurality of consumables is a print fluid waste area of the maintenance cartridge, to receive print fluid generated in a print fluid waste action.

12. A print apparatus according to claim 11, wherein the controller is to move a carriage of the print apparatus to position the maintenance cartridge relative to a print fluid dispenser nozzle or nozzles which is to perform the print fluid waste action, to receive print fluid from the print fluid dispenser nozzle or nozzles in the selected print fluid waste area.

13. A print apparatus according to claim 12, wherein the controller is to select which of the consumables to use further based on which of the consumables is most accessible based on a current state of the print apparatus.

14. A non-transitory machine readable medium, storing instructions which, when executed by a processing resource, cause the processing resource to:
determine a usage level of a first consumable and a second consumable of a replaceable element of a print apparatus;
for an action of the print apparatus that can use either the first consumable or the second consumable, determine whether to use the first consumable or the second consumable based on the determined usage levels.

15. A non-transitory machine readable medium according to claim 14,
wherein determining the usage levels comprises retrieving a tracking counter associated with each of the first and second consumables; and
wherein the non-transitory machine readable medium further comprises instructions to control the print apparatus to perform the action using the determined consumable, and update the tracking counter associated with the determined consumable.
